(19) United States
(12) Patent Application Publication
(10) Pub. No.: US 2005/0223373 A1
(43) Pub. Date: Oct. 6, 2005

(54) Method for updating the firmware of a device

(75) Inventors: Donald B. Gage, Cedar Park, TX (US); Manuel Rivera JR., Pflugerville, TX (US); Munif Halloush-Farhan, Round Rock, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 10/818,305

(22) Filed: Apr. 5, 2004

(51) Int. Cl. G06F 9/44

(52) U.S. Cl. 717/168

(57) ABSTRACT

A firmware update methodology is disclosed in which a universal firmware update application is used to save or flash a firmware update to a target device.

### TECHNICAL FIELD

The present disclosure relates generally to the field of computer systems or information handling systems, and, more particularly, to a system and method for providing a firmware update to a target device of a system.

### BACKGROUND

As the value and use of information continues to increase, individuals and businesses continually seek additional ways to process and store information. One option available to users of information is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Many information handling systems include one or more devices that process instructions from and operate on the basis of firmware embedded in or near the device. Firmware is program code embedded in a device and maintained within or near the device. The firmware for a device most often comprises the operational code for the device. Firmware is often stored in flash memory, which is a class of memory that is rewritable and is able to hold its content without power. From time to time, it may be necessary or desirable to update or upgrade the firmware of a device. A firmware upgrade may be necessary to correct errors in or improve the performance of the device. The process of updating the firmware of a device is sometimes referred to as “flashing” the device, as the firmware update program will replace the current firmware stored in the flash memory of the device with a firmware update. One example of devices that include firmware are optical drives, which are characterized by the ability to read or write by laser beams from optical media.

A developer and manufacturer of computer systems may use optical drives from several suppliers in its computer systems. Each optical drive supplier often may employ a different technique for flashing or updating the firmware of the drive. As an example, the interface for the flash utility for each drive may be differ among optical drives, and the steps required to update the drive may differ among optical drives. Thus, if a user has multiple optical drives in a computer system, the user may, depending on the supplier and model of the drives, employ two different techniques for updating the firmware of the drives. The lack of uniformity in the process of updating the firmware presents challenges for both the computer manufacturer and the user. For the computer manufacturer, having a number of different methodologies for updating the firmware of an optical drive forces the computer manufacturer to support each of these methodologies. For the user, the existence of a number of different methodologies for updating the firmware of an optical drive leads to confusion in the use of the computer system and may cause the use to consult customer support for assistance. The difficulty of non-uniformity among firmware update methodologies is not limited to optical drives. Other devices in a computer system may present similar difficulties with respect to updating the firmware of the drive.

### SUMMARY

In accordance with the present disclosure, a firmware update methodology is disclosed in which a universal firmware update application is used to save or flash a firmware update to a target device of a computer system or information handling system.

A technical advantage of the present disclosure is the use of a universal firmware update application for updating or flashing the firmware of each target device of the system. The firmware update application is universal in its use, as it can be used with a range of potential devices in the system and without reference to the supplier of the device. Another technical advantage of the firmware update method disclosed herein is its ease of use for users or administrators of the system. Because the user or administrator is presented with a single application for flashing the firmware of all devices of the system, the user need not learn to use a separate flash utility for each device of the system. The ease of the firmware update application improves the experience of the user with respect to the operation of the computer system. In addition, because the firmware update application functions with any number of devices, a new firmware update to a target device can be accomplished by downloading only the firmware itself. Because the firmware update application is in place and operational with respect to the target device, the user need not download a separate utility for flashing the target device, thereby reducing the size and time required for the download of files required for a firmware update.

Another technical advantage of the method disclosed herein is the firmware update application may be programmed to operated as a Windows®-based application, thereby eliminating the need to run drive-specific DOS-based applications. The firmware update method disclosed herein is also advantageous in that it includes controls for verifying that the only authorized firmware updates are flashed to the target device and for verifying that the firmware update was performed successfully. Another technical advantage of the firmware update method disclosed herein is that the method is not dependent on the booting of a system from a floppy drive. The firmware update application may be initiated while the system is in an operational mode. The firmware update method described herein may be used in computer systems or information handling systems that do not include a floppy disk drive. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of an architecture of a computer system;

FIG. 2 is a diagram of the logical communication flow between a target device and a firmware update application;

FIG. 3 is a flow diagram of a series for updating the firmware of a target device;

FIG. 4 is a diagram of a firmware update file.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components. An information handling system, including a computer system, will typically include a number of devices that include firmware.

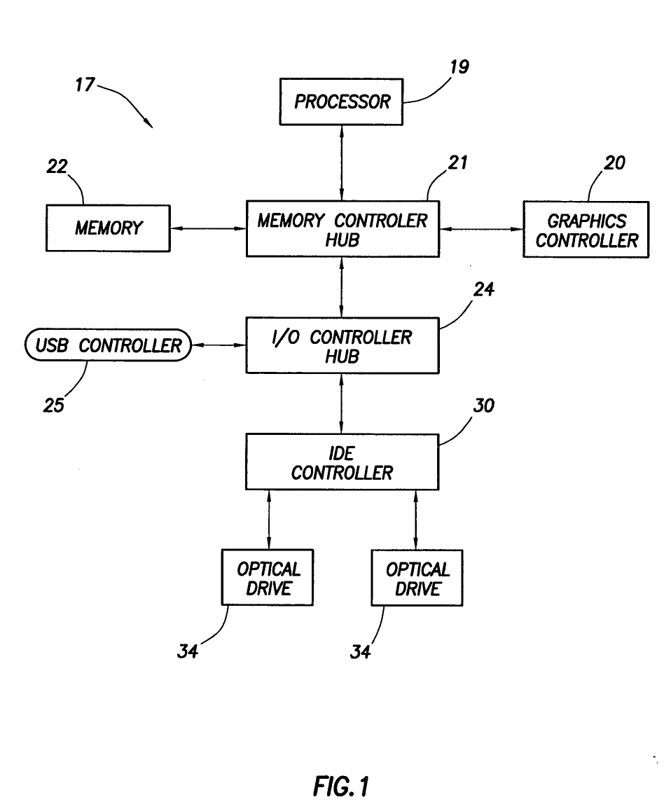

The architecture of a computer system, which is indicated generally at 17, is shown in FIG. 1. Computer system 17 includes a processor 19, which is coupled to a memory controller hub (MCH) 21. Memory controller hub 21 is coupled to a graphics controller 20 and system memory 22. Memory controller hub 21 is additionally coupled to an I/O controller hub (ICH) 24, which is coupled to an IDE controller 30. Coupled to IDE controller 30 are optical drives 34. Although the technique disclosed herein may be used to update the firmware of optical drives 34, it should be recognized that the firmware update technique may also be used to update other devices, such as a hard disk drives and video cards, that are not shown in the architecture diagram of FIG. 1.

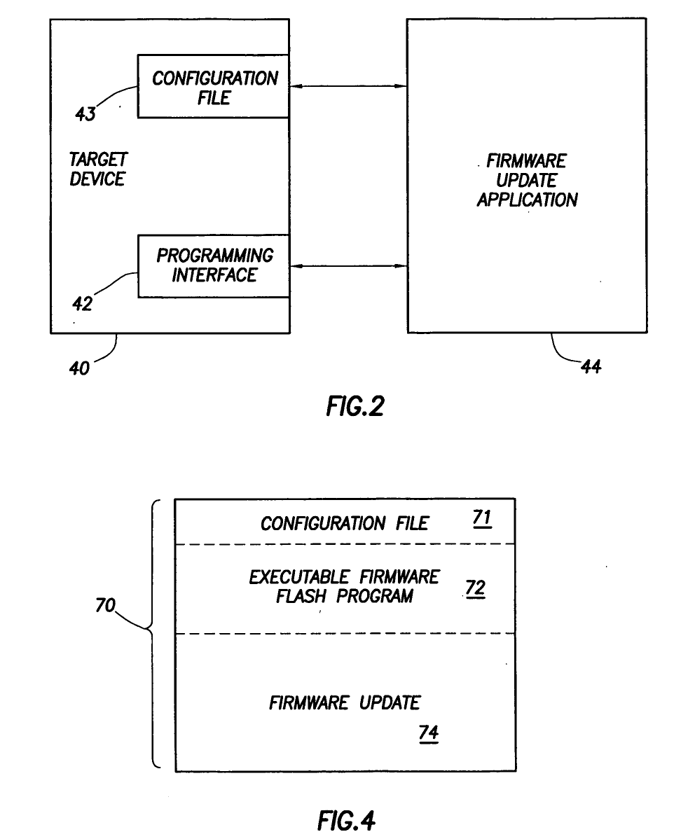

Shown in FIG. 2 is a diagram of the logical communication flow between a target device 40 and a firmware update application 44. Target device 40 includes a configuration file 43 and a programming or input interface 42. Configuration file 43 identifies the operational characteristics and data necessary for performing a firmware update or firmware flash on the target device. Programming interface 42 provides an input for initiating a firmware update at the target device. Firmware update application 44 is shown as having a logical communications link with target device 40 through configuration file 43 and programming interface 42. Configuration file 43 identifies the inputs expected by the programming interface for a firmware update operation. Configuration file 43 also includes a target device identifier, which is a data string that uniquely identifies the target device by its supplier and model. Firmware update application 44 may be a utility that runs on Windows® and may be accessible by a user or administrator of the computer system. Windows® is a product of Microsoft® Corporation of Redmond, Wash.

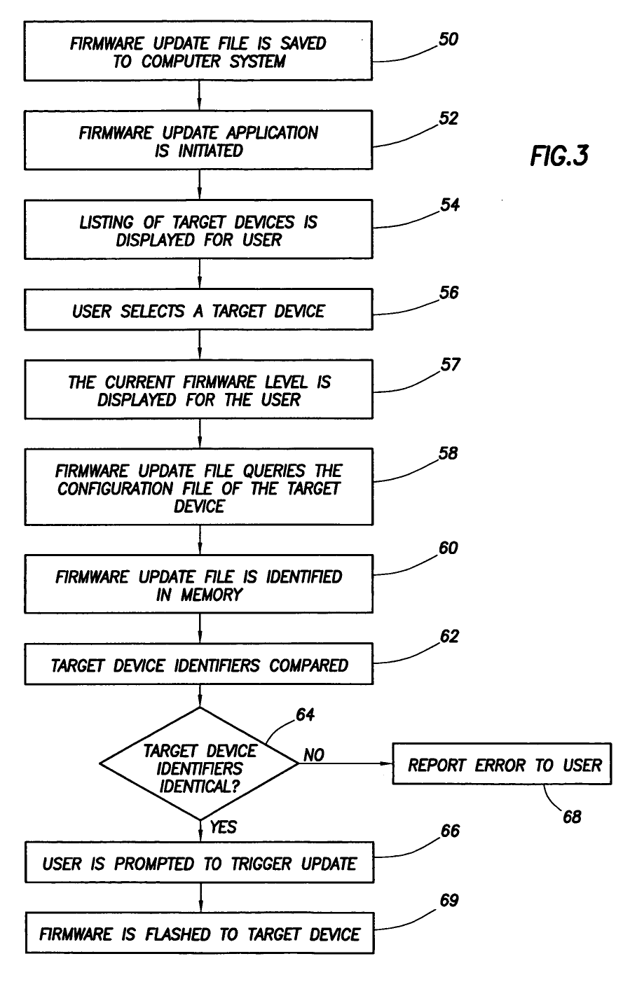

The operation of the universal firmware update application 44 to perform an update of the firmware of a target device is shown in FIG. 3. At step 50, the firmware update file is saved to a storage location in the computer system. The firmware update file may be provided by the manufacturer of the computer system or the supplier of the target device. The firmware update file may, for example, be saved to the computer system through a storage drive or a communications network. The content of the firmware update file is shown in FIG. 4. Firmware update file 70 includes a configuration file 71, an executable firmware flash program 72, and a firmware update 74. Firmware update 74 comprises the code that will be saved or flashed to the non-volatile memory space of the target device as part of the firmware update process. Configuration file 71 contains data concerning the firmware update file. Configuration file 71 may include, for example, a pointer to firmware update 74 and an indication of the length of the storage block that includes firmware update 74. At step 52 of FIG. 3, firmware update application 44 is initiated. At step 54, the firmware update application identifies and displays for the user a listing of target devices whose firmware may be updated. The listing of target devices may be compiled by a scan of the computer system.

With reference to FIG. 3, at step 56, the user selects from a list of devices a target device for the firmware update. Following the selection of the target device, the current firmware release of the device is displayed for the user. The display of the currently installed firmware release provides an opportunity for the user or administrator of the computer system to evaluate whether the firmware installed in the target device is more current or for any reason more desirable than the firmware to be installed in the target device. If the firmware currently installed in the target device is more current than the firmware proposed to be installed, the user or administrator can terminate the firmware update application. At step 58, the firmware update application queries a configuration file associated with the target device. This configuration file identifies for the firmware update application the input parameters expected by the target device during the firmware update operation. At step 60, the user identifies the firmware update file in the storage of the computer system.

At step 62, a target device identifier associated with the target device is compared with a target device identifier of the firmware update file. If it is determined at step 64 that the target device identifiers match, the user is prompted at step 66 to trigger the update of the firmware of the target device. If it is determined at step 64 that the target device identifiers of the target device and the firmware update file do not match, an error is reported to the user at step 68. At step 69, following the user's initiation of the flashing of the firmware update, the firmware update is applied or flashed to the target device.

Firmware update 74 of the firmware update file 70 is flashed to the target device by the executable firmware flash program 72. Executable firmware flash program 72 may be designed specifically for the target device and is typically provided by the supplier of the target device. The executable firmware flash program 72 is initiated by the firmware update application to cause the firmware update to be saved or flashed to the target device. Because the executable firmware flash program is provided by the supplier of the target device, the executable firmware flash program can be specifically designed to interact with the target device to flash the firmware update to the target device. Even though the executable firmware flash program of the firmware update file is specific to the target the device, the universal firmware update application 44 serves as the means by the which the user initiates the update of a target device with firmware. The user interacts only with the universal firmware update application. The firmware update application in turn initiates a supplier-provided firmware executable application, which executes in the background relative to the view of the user or administrator of the computer system to update or flash the firmware update to the target device of the computer system.

Following the application of the firmware update to the target device, the firmware update application may perform a comparison of the firmware of the target device with the firmware update that is stored in the storage of the computer system to verify that the update was successful. Following the application of the firmware update to the target device, the target device, the computer system, or both may be reset or booted.

The firmware update application described herein operates universally with respect to the target devices of the computer system. The firmware update application is not written such that it will function for any one target device. In this way, the firmware update application is not specific or exclusive to any target device in the computer system. Rather, the firmware update application will function with a wide range of target devices by operating with the configuration files and programming inputs of the target devices. It should also be understood that the system and method disclosed herein is not limited to the precise architecture disclosed in the figures of the present disclosure. It should also be understood that the system and method disclosed herein is not limited in its application to updating the firmware of a specific device. Rather, the system and method disclosed herein may be used to update the firmware of any number of devices. Finally, it should be recognized that the firmware update technique disclosed herein may be used to update target devices in a number of information handling systems, including routers, switches, and gateway devices. Although the present disclosure has been described in detail, it should be understood that various changes, substitutions, and alterations can be made hereto without departing from the spirit and the scope of the invention as defined by the appended claims.

1. A method for providing a firmware update to a target device of a computer system, comprising the steps of:
providing a firmware update to the computer system;
initiating a firmware update application, wherein the firmware update application is not for exclusive use with the target device of the computer system;
comparing an identifier associated with the firmware update to an identifier associated with the target device; and
loading the firmware update on the target device if the identifier associated with the firmware update corresponds with the identifier associated with the target device.

2. The method for providing a firmware update to a target device of a computer system of claim 1, wherein the step of providing a firmware update to the computer system comprises the step of providing a firmware update file comprising firmware and an identifier corresponding to the target device.

3. The method for providing a firmware update to a target device of a computer system of claim 2, wherein the step of providing a firmware update to the computer system comprises the step of saving the firmware update to a memory location in the computer system.

4. The method for providing a firmware update to a target device of a computer system of claim 1, further comprising the steps of:
providing a list of target devices having firmware for selection by the user; and
retrieving an identifier from the target device selected by the user.

5. The method for providing a firmware update to a target device of a computer system of claim 1, further comprising the step of transmitting an error notification if the identifier associated with the firmware update does not correspond with the identifier associated with the target device

6. The method for providing a firmware update to a target device of a computer system of claim 1, further comprising the step of verifying that the firmware update was successfully completed.

7. The method for providing a firmware update to a target device of a computer system of claim 2, further comprising the step of comparing the updated firmware of the target device with the firmware provided to the computer system.

8. A method for performing a firmware update to a target device in an information handling system, comprising the steps of:
providing a firmware update file, wherein the firmware update file includes firmware to be saved to the target device;
initiating a firmware update application at the information handling system, wherein the firmware update application is operable to perform a firmware update operation on multiple devices in the information handling system;
receiving a selection of a target device;
verifying that the firmware update file is associated with the selected target device; and
saving the firmware of the firmware update file to the target device.

9. The method for performing a firmware update to a target device in an information handling system of claim 8, further comprising the step of verifying that the firmware was successfully saved to the target device.

10. The method for performing a firmware update to a target device in an information handling system of claim 9, wherein the step of verifying that the firmware was successfully saved to the target device comprises the step of comparing the firmware of the target device to the firmware of the firmware update file.

11. The method for performing a firmware update to a target device in an information handling system of claim 8, wherein the firmware update file comprises an identifier associated with the target device and firmware.

12. The method for performing a firmware update to a target device in an information handling system of claim 11, wherein the step of verifying that the firmware update file is associated with the selected target device comprises the step of comparing the identifier from the firmware update file with an identifier associated with the target device.

13. The method for performing a firmware update to a target device in an information handling system of claim 8, wherein the step of providing a firmware update file comprises the saving the firmware update file to a location in the memory of the information handling system.

14. The method for performing a firmware update to a target device in an information handling system of claim 13, wherein the step of providing a firmware update file comprises the step of identifying the firmware update file in the memory of the information handling system.

15. A method for flashing a firmware update to a target device in a computer system, comprising the steps of:
providing the firmware update to the computer system;
initiating a firmware update application, the firmware application being operable with respect to the set of target devices of the computer system;
receiving a selection of a target device;
verifying that the firmware update corresponds to the selected target device; and
flashing the firmware update to the selected target device.

16. The method for flashing a firmware update to a target device in a computer system of claim 15, further comprising the step of verifying the flash of the firmware to the selected target device.

17. The method for flashing a firmware update to a target device in a computer system of claim 16, wherein the step of verifying the flash of the firmware to the selected target device comprises the step of comparing the firmware of the target device with the firmware update.

18. The method for flashing a firmware update to a target device in a computer system of claim 15, wherein the step of providing a firmware update to the computer system, comprises the step of saving the firmware update to the computer system.

19. The method for flashing a firmware update to a target device in a computer system of claim 18, wherein the firmware update comprises an indicator corresponding to a target device and firmware.

20. The method for flashing a firmware update to a target device in a computer system of claim 19, wherein the firmware update comprises a configuration file accessible by the firmware update application for performing the flash of the firmware to the target device.
